(19) United States
(12) Patent Application Publication
(10) Pub. No.: US 2007/0143633 A1
(43) Pub. Date: Jun. 21, 2007

(54) Copyright information management method

(76) Inventors: Hidetaka Shiiba, Osaka (JP); Yasuo Okumura, Kyoto (JP)

Correspondence Address: MCDERMOTT WILL & EMERY LLP, 600 13TH STREET, N.W., WASHINGTON, DC, 20005-3096, US

(21) Appl. No.: 11/640,391

(22) Filed: Dec. 18, 2006

(30) Foreign Application Priority Data
Dec. 20, 2005 (JP) 2005-366889

(51) Int. Cl. G06F 12/14; H04N 7/16; H04L 9/32; G06Q 99/00; H04L 9/00

(52) U.S. Cl. 713/193; 713/169; 726/26; 726/27; 705/51; 705/57

(57) ABSTRACT

The present invention relates to a method for managing copyright information on content stored in a storage medium including a protected region, which is accessible after mutual authentication, and a data region, which is accessible without mutual authentication. This method includes: the step of storing, in the protected region, encrypted copyright information obtained by encrypting the copyright information, and the content storing step of storing, in the data region, encrypted information that contains the content, and copyright information conversion information that contains copyright information, which is to be set for the content and corresponds to a format.

### CROSS-REFERENCE TO RELATED APPLICATION

This application claims priority under 35 U.S.C. §119 to Japanese Patent Application No. 2005-366889 filed on Dec. 20, 2005, the entire contents of all of which are incorporated herein by reference.

### BACKGROUND OF THE INVENTION

The present invention relates to a method for managing copyright information on digital content, and particularly relates to a method for managing copyright information on digital content whose format is changed.

More and more digital AV (audiovisual) equipment for processing digitized video/audio and other content, mobile communication equipment and the like (which will be hereinafter collectively referred to as “digital devices”) have the function of retaining content in portable storage media. Some (for example, SD (secure digital) memory cards) of the portable storage media for retaining digital content have the function of protecting copyright on the content to realize the protection of the content itself and copyright information thereon (i.e., information on whether or not playback is allowed, whether or not copying is allowed, how many times copying can be performed, and the like). Various other methods for managing digital content and copyright thereon are also defined by content providing services, content processing devices, content recording media, and the like.

There are a variety of formats for digital content. Specifically, examples of the formats for moving picture content include MPEG-2 (moving picture experts group-2), MPEG-4 Video, and so on, while examples of the formats for audio content include MPEG-1 Layer 3, MPEG-2 Layer 3, MPEG-2 AAC (advanced audio coding), MPEG-4 AAC, and the like. Since these formats differ from each other in intended use, performance, processing method, etc., the copyright holder must define copyright information on the content in each format.

For example, Japanese Laid-Open Publication No. 2002-123496 discloses a method for performing copyright information conversion between different copyright information management methods.

Formats for digital content differ from each other in intended use, performance, processing method, and hardware and software resources required for processing. Therefore, a digital device for processing content selects a format corresponding to the intended use of the device and processes content in that format.

When digital content is stored in a portable storage medium for copying and playback of the content by a plurality of digital devices, specific types of devices may not be able to process the content depending on the format of the content. In such a case, the content is converted into a format that those devices can process, and the converted content is recorded (for example, in order for a cellular phone only having the capability of processing MPEG-4 content to play back MPEG-2 content stored in a portable storage medium, the MPEG-2 content is converted into content in MPEG-4 format, and the MPEG-4 content is recorded).

Copyright information on content needs to be defined individually in accordance with the intent of the copyright holder that varies depending on how the content is used and the quality of the content. Nevertheless, where the format of content is converted before the content is used, copyright information that is the same as copyright information on the content before the format conversion has been often set for the content after the format conversion.

### SUMMARY OF THE INVENTION

It is therefore an object of the present invention to protect copyright on content which is stored in a storage medium and whose format is converted, in accordance with the format of the content after the conversion.

Specifically, a first inventive method is a method for managing copyright information on content stored in a storage medium including a protected region, which is accessible after mutual authentication, and a data region, which is accessible without mutual authentication. The method includes: the step of storing, in the protected region, encrypted copyright information obtained by encrypting the copyright information, and the content storing step of storing, in the data region, encrypted information that contains the content, and copyright information conversion information that contains copyright information, which is to be set for the content and corresponds to a format.

According to the first inventive method, the copyright information conversion information that contains the copyright information in accordance with the format is stored. Therefore, where the format conversion is performed, the copyright information on the content can be set in accordance with the format after the conversion.

A second inventive method is a method for managing copyright information on content stored in a storage medium including a protected region, which is accessible after mutual authentication, and a data region, which is accessible without mutual authentication. The method includes: the step of reading, from the protected region, encrypted copyright information obtained by encrypting the copyright information, and decrypting the encrypted copyright information, thereby obtaining the copyright information; the content reading step of reading, from the data region, encrypted information that contains the content, and copyright information conversion information that contains copyright information, which is to be set for the content and corresponds to a format; the decryption step of decrypting the encrypted information that contains the content; the format conversion step of converting the format of the content; and the copyright information conversion step of converting the copyright information into information that corresponds to a format in which the content after the format conversion is in, in accordance with the copyright information conversion information.

According to the second inventive method, the copyright information conversion information that contains the copyright information in accordance with the format is used. Therefore, the copyright information on the content after the format conversion can be converted into information corresponding to the format. It is thus possible to protect the copyright on the content in an appropriate manner in accordance with the format after the conversion.

According to the present invention, it is possible to set the copyright information on the content in accordance with the format, which enables the copyright on the content to be protected more suitably.

### BRIEF DESCRIPTION OF THE DRAWINGS

FIG. 1 is a block diagram illustrating the structure of a copyright information management device according to a first embodiment of the present invention.

FIG. 2 is a block diagram illustrating the structure of a storage medium shown in FIG. 1 and an example of information stored in the storage medium.

FIG. 3 is an explanatory view illustrating an example of copyright information conversion information shown in FIG. 2.

FIG. 4 is a flow chart indicating the sequence of processing steps in a copyright information management method according to the first embodiment of the present invention.

FIG. 5 is a block diagram illustrating the structure of a storage medium according to a second embodiment and an example of information stored in the storage medium.

FIG. 6 is an explanatory view illustrating an example of encrypted copyright information conversion information shown in FIG. 5.

FIG. 7 is a flow chart indicating the sequence of processing steps in a copyright information management method according to the second embodiment of the present invention.

FIG. 8 is a block diagram illustrating the structure of a storage medium according to a third embodiment and an example of information stored in the storage medium.

FIG. 9 is an explanatory view illustrating an example of encrypted copyright information conversion information shown in FIG. 8.

FIG. 10 is a flow chart indicating the sequence of processing steps in a copyright information management method according to the third embodiment of the present invention.

FIG. 11 is a block diagram illustrating the structure of a storage medium according to a fourth embodiment and an example of information stored in the storage medium.

FIG. 12 is a flow chart indicating the sequence of processing steps in a copyright information management method according to the fourth embodiment of the present invention.

FIG. 13 is a block diagram illustrating the structure of a storage medium according to a modified example of the fourth embodiment and an example of information stored in the storage medium.

FIG. 14 is a flow chart indicating the sequence of processing steps in a copyright information management method according to the modified example of the fourth embodiment of the present invention.

FIG. 15 is a block diagram illustrating the structure of a storage medium according to a fifth embodiment and an example of information stored in the storage medium.

FIG. 16 is a flow chart indicating the sequence of processing steps in a copyright information management method according to the fifth embodiment of the present invention.

FIG. 17 is a block diagram illustrating the structure of a storage medium according to a modified example of the fifth embodiment and an example of information stored in the storage medium.

FIG. 18 is a flow chart indicating the sequence of processing steps in a copyright information management method according to the modified example of the fifth embodiment of the present invention.

FIG. 19 is a block diagram illustrating the structure of a storage medium according to a sixth embodiment and an example of information stored in the storage medium.

FIG. 20 is a flow chart indicating the sequence of processing steps in a copyright information management method according to the sixth embodiment of the present invention.

FIG. 21 is a block diagram illustrating the structure of a storage medium according to a seventh embodiment and an example of information stored in the storage medium.

FIG. 22 is a flow chart indicating the sequence of processing steps in a copyright information management method according to the seventh embodiment of the present invention.

FIG. 23 is a flow chart indicating the sequence of processing steps in a copyright information management method according to an eighth embodiment of the present invention.

FIG. 24 is a flow chart indicating the sequence of processing steps in a copyright information management method according to a modified example of the eighth embodiment of the present invention.

### DETAILED DESCRIPTION OF THE INVENTION

Hereinafter, preferred embodiments of the present invention will be described with reference to the accompanying drawings.

### First Embodiment

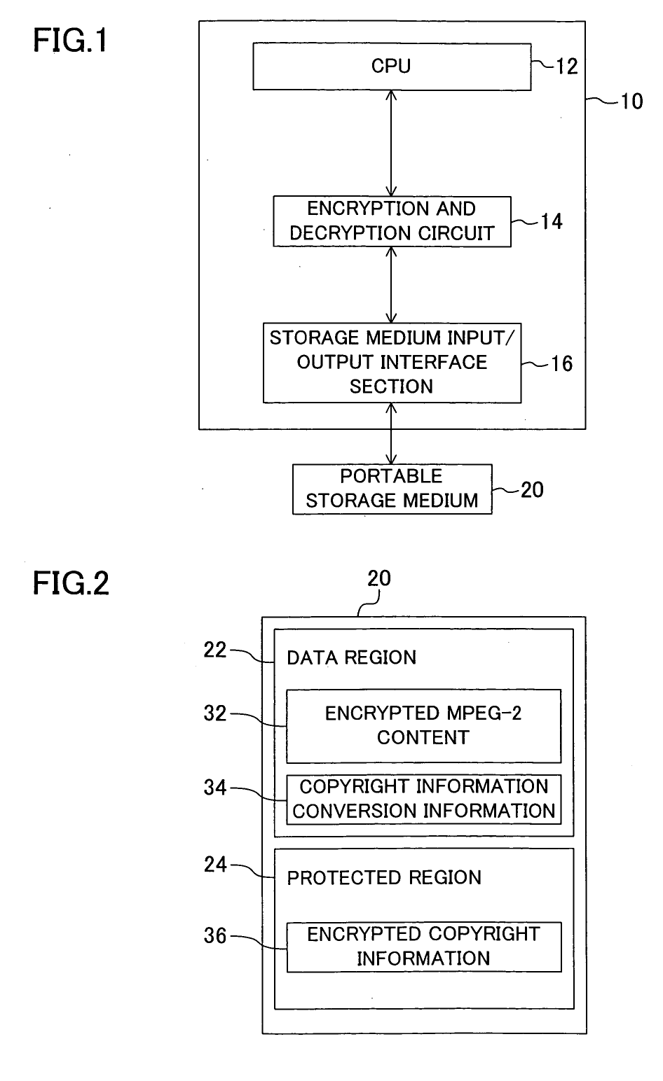

FIG. 1 is a block diagram illustrating the structure of a copyright information management device according to a first embodiment of the present invention. The copyright information management device 10 shown in FIG. 1 includes a CPU 12, an encryption and decryption circuit 14, and a storage medium input/output interface section 16. A portable storage medium 20 is connected in a detachable manner to the storage medium input/output interface section 16. The storage medium 20 is an SD memory card, for example.

The CPU 12 controls the encryption and decryption circuit 14 and the storage medium input/output interface section 16. The storage medium input/output interface section 16 reads data from the storage medium 20 to output the read data to the CPU 12 or to the encryption and decryption circuit 14, and writes data received from the CPU 12 or from the encryption and decryption circuit 14 into the storage medium 20. The encryption and decryption circuit 14 encrypts or decrypts the received data in accordance with an instruction from the CPU 12 and outputs the encrypted or decrypted data.

FIG. 2 is a block diagram illustrating the structure of the storage medium 20 shown in FIG. 1 and an example of information stored in the storage medium 20. The storage medium 20 includes a data region 22 and a protected region 24. The protected region 24 becomes accessible, after mutual authentication is performed between the storage medium 20 and the device that is going to access the storage medium 20. The data region 22 is accessible without mutual authentication. The data region 22 holds encrypted MPEG-2 content 32 and copyright information conversion information 34, while the protected region 24 retains encrypted copyright information 36.

For example, the CPU 12 stores the encrypted copyright information 36 in the protected region 24 and stores the encrypted MPEG-2 content 32 and the copyright information conversion information 34 in the data region 22 through the storage medium input/output interface section 16. The encrypted copyright information 36 is information obtained by encrypting copyright information. In the case of an SD memory card, the mutual authentication and encryption/decryption method is called CPRM (content protection for recordable media).

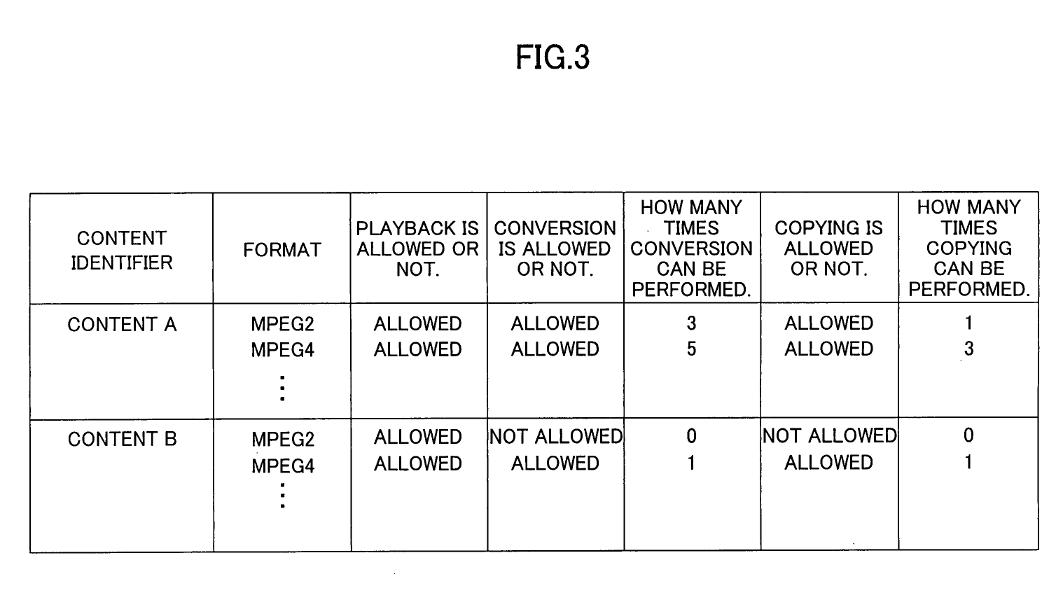

FIG. 3 is an explanatory view illustrating an example of the copyright information conversion information 34 shown in FIG. 2. As shown in FIG. 3, the copyright information conversion information 34 contains content identifiers each indicating the name of content, format information indicating whether information is for MPEG-2 format or MPEG-4 format, and attribute information indicating whether or not playback is allowed, whether or not format conversion is allowed, and the like. The attribute information contains copyright information that should be set for the content in each format. The attribute information may contain items of information on a plurality of contents, in which case, the contained items of copyright information correspond to the combinations of the contents and the formats.

Specifically, as shown in FIG. 3, for example, the copyright information is information that indicates whether or not playback is allowed, whether or not format conversion is allowed, how many times format conversion can be performed, whether or not copying is allowed, how many times copying can be performed, and the like. The owner of the copyright to the content sets the copyright information conversion information 34 in such a manner that copyright information that the owner wants to set for the content after format conversion is contained.

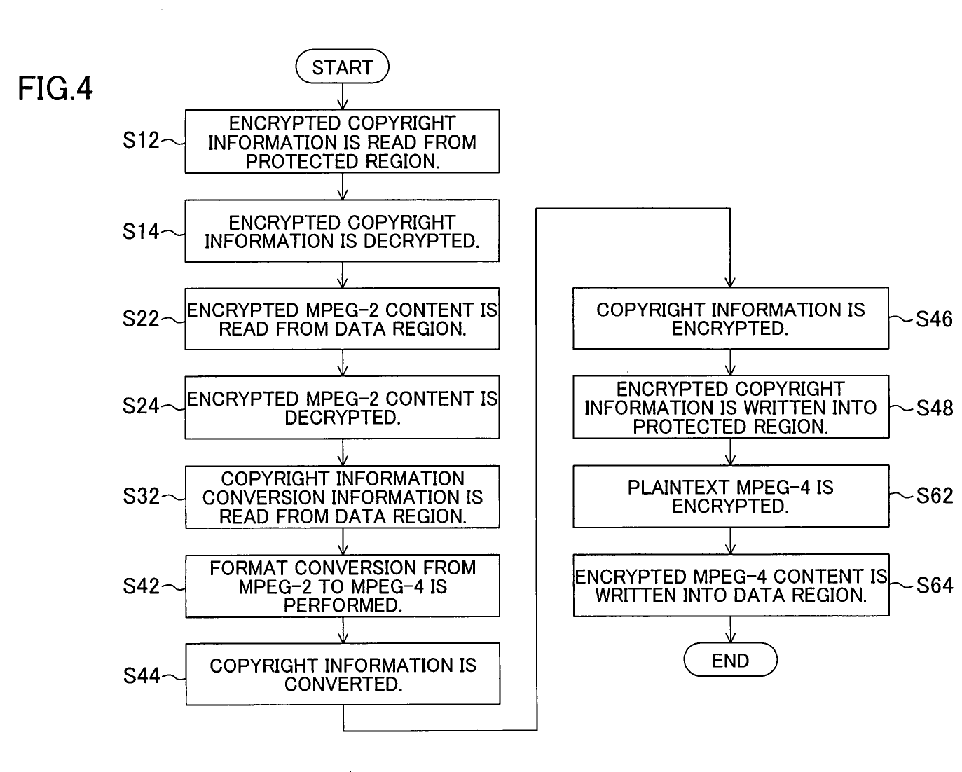

FIG. 4 is a flow chart indicating the sequence of processing steps in a copyright information management method according to the first embodiment of the present invention. With reference to FIG. 4, a case in which content A in MPEG-2 format is converted into content A in MPEG-4 format will be described as an example.

In a step S12, the CPU 12 performs mutual authentication between the CPU 12 and the storage medium 20 by using an authentication key. The CPU 12 then reads the encrypted copyright information 36 from the protected region 24 in the storage medium 20. In a step S14, the encryption and decryption circuit 14 decrypts the encrypted copyright information 36 by using a key for decryption, thereby obtaining copyright information in plain text.

In a step S22, the CPU 12 reads the encrypted MPEG-2 content 32 from the data region 22 in the storage medium 20. In a step S24, the encryption and decryption circuit 14 decrypts the encrypted MPEG-2 content 32 to obtain MPEG-2 content in plain text. In a step S32, the CPU 12 reads the copyright information conversion information 34 from the data region 22.

In a step S42, the CPU 12 refers to the copyright information conversion information 34; when the copyright information conversion information 34 indicates that the conversion of the content A into the MPEG-4 format is allowed, the CPU 12 performs the format conversion in which the plaintext MPEG-2 content obtained in the step S24 is converted into the MPEG-4 format, thereby obtaining the MPEG-4 content in plain text.

In a step S44, according to the copyright information conversion information 34, the CPU 12 converts the copyright information into copyright information that corresponds to the MPEG-4 format. In this step, the CPU 12 converts the copyright information in such a manner that the information on the content A in the MPEG-4 format shown in FIG. 3 is contained. This copyright information contains the information indicating that playback is allowed, conversion is allowed, and the like. Since the conversion into the MPEG-4 format has been done, the CPU 12 updates the information in the copyright information conversion information 34 on the MPEG-4 format of the content A and stores the copyright information conversion information 34 after the update into the data region 22.

In a step S46, the encryption and decryption circuit 14 encrypts the copyright information after the conversion with a key for encryption, thereby obtaining new encrypted copyright information. In a step S48, the CPU 12 performs mutual authentication between the CPU 12 and the storage medium 20 using the authentication key. Thereafter, the encryption and decryption circuit 14 writes the encrypted copyright information obtained in the step S46 into the protected region 24.

In a step S62, the encryption and decryption circuit 14 encrypts the plaintext MPEG-4 content after the format conversion, thereby obtaining encrypted MPEG-4 content. In a step S64, the CPU 12 writes the encrypted MPEG-4 content into the data region 22.

In this embodiment, when the encrypted content is converted into a different format, the copyright information on the content can be set in accordance with the format after the conversion.

Format conversion from MPEG-2 to MPEG-4 is basically processing for converting high quality MPEG-2 content into lower quality MPEG-4 content. As shown in FIG. 3, therefore, in the case of the conversion to the MPEG-4 format, the copyright information conversion information 34 may be defined so that the allowable number of conversions is increased as compared with a case in which conversion to the MPEG-2 format is performed, for example. Then, the right of the content user can be expanded by converting the copyright information in accordance with the copyright information conversion information 34.

In the exemplary case described in this embodiment, the storage medium 20 retains the encrypted MPEG-2 content 32. Nevertheless, the storage medium 20 may retain content in other format.

### Second Embodiment

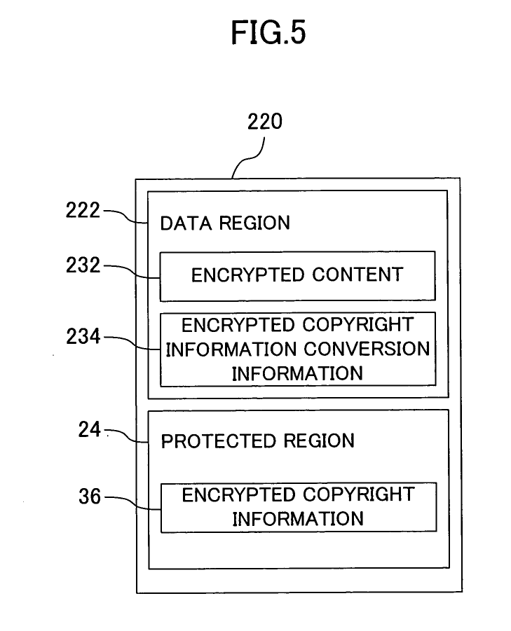

FIG. 5 is a block diagram illustrating the structure of a storage medium 220 according to a second embodiment and an example of information stored in the storage medium 220. In this embodiment, the storage medium 220 is used in place of the storage medium 20 in FIG. 1. The storage medium 220 includes a data region 222 and a protected region 24. The data region 222 retains encrypted content 232 and encrypted copyright information conversion information 234, while the protected region 24 holds encrypted copyright information 36. For example, a CPU 12 stores the encrypted copyright information 36 in the protected region 24 and stores the encrypted content 232 and the encrypted copyright information conversion information 234 in the data region 222.

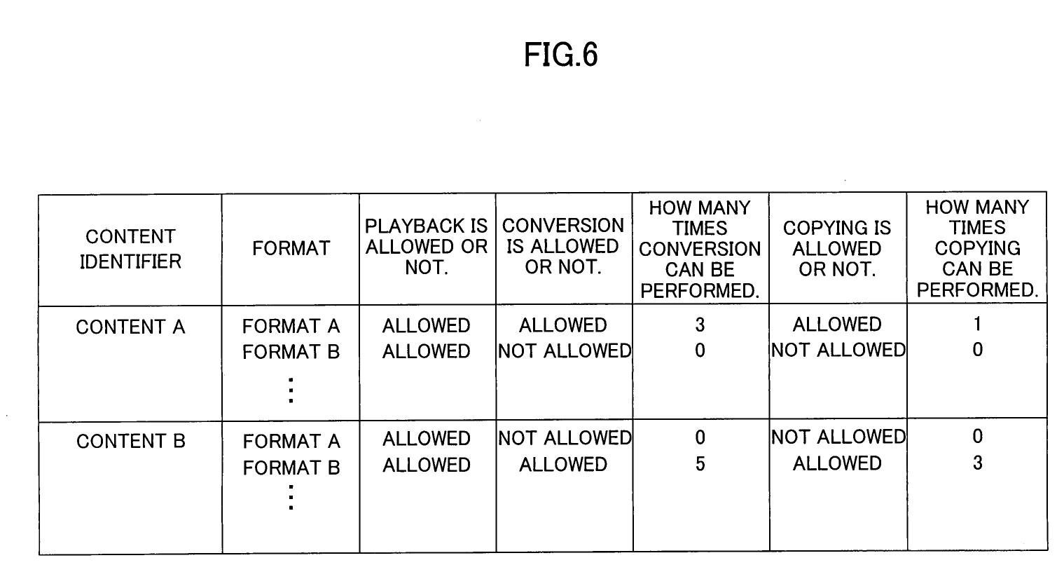

FIG. 6 is an explanatory view illustrating an example of the encrypted copyright information conversion information 234 shown in FIG. 5. The encrypted copyright information conversion information 234 is information obtained by encrypting copyright information conversion information. As shown in FIG. 6, this copyright information conversion information contains format information indicating whether information is for the format A, B, etc.

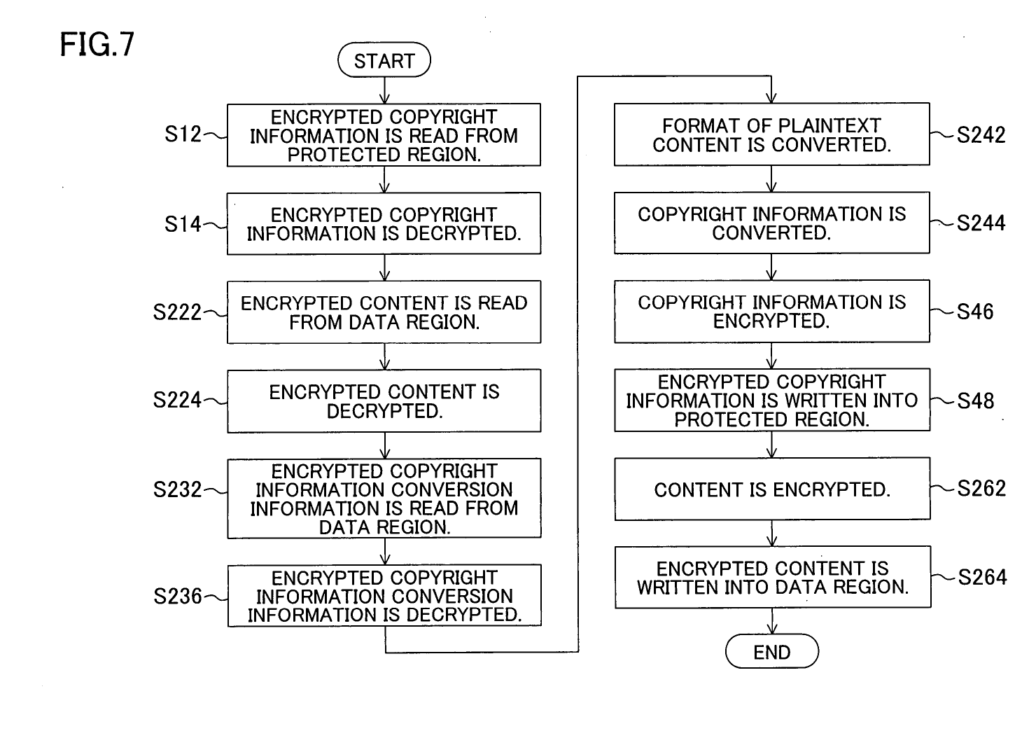

FIG. 7 is a flow chart indicating the sequence of processing steps in a copyright information management method according to the second embodiment of the present invention. With reference to FIG. 7, a case in which content A in format B is converted into content A in format A will be described as an example. Steps S12, S14, S46, and S48 are the same as those shown in FIG. 4, and the descriptions of these steps will be thus omitted herein.

In a step S222 shown in FIG. 7, the CPU 12 reads the encrypted content 232 from the data region 222 in the storage medium 220. In a step S224, an encryption and decryption circuit 14 decrypts the encrypted content 232 to obtain content A in format B in plain text. In a step S232, the CPU 12 reads the encrypted copyright information conversion information 234 from the data region 222. In a step S236, the encryption and decryption circuit 14 decrypts the encrypted copyright information conversion information 234 to obtain copyright information conversion information in plain text.

In a step S242, the CPU 12 converts the format of the plaintext content obtained in the step S224 in accordance with the copyright information conversion information. In this embodiment, the format conversion from the format B to the format A is carried out.

In a step S244, according to the plaintext copyright information conversion information obtained in the step S236, the CPU 12 converts the copyright information into copyright information that corresponds to the format A. In this step, the CPU 12 converts the copyright information in such a manner that the information on the format A for the content A shown in FIG. 6 is contained. Since the conversion into the format A has been performed, the CPU 12 updates the information in the copyright information conversion information on the format A for the content A. The encryption and decryption circuit 14 encrypts the copyright information conversion information after the update, and the CPU 12 stores the obtained encrypted copyright information conversion information 234 into the data region 222.

In a step S262, the encryption and decryption circuit 14 encrypts the plaintext content A after the format conversion, thereby obtaining new encrypted content 232. In a step S264, the CPU 12 writes the encrypted content 232 obtained in the step S262 into the data region 222.

In this embodiment, since the copyright information conversion information is encrypted and then stored in the storage medium 220, the possibility that the copyright information conversion information is altered is reduced.

### Third Embodiment

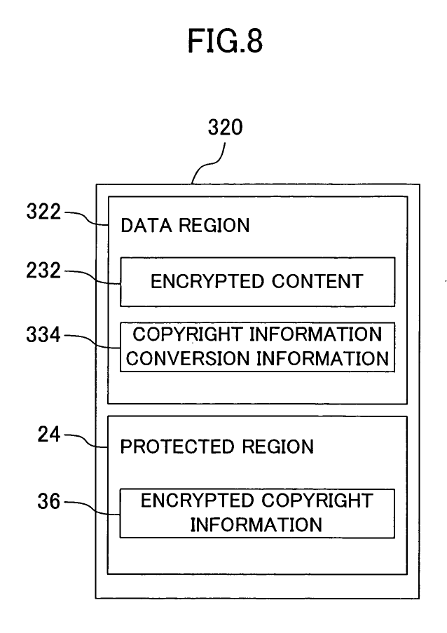

FIG. 8 is a block diagram illustrating the structure of a storage medium 320 according to a third embodiment and an example of information stored in the storage medium 320. In this embodiment, the storage medium 320 is used in place of the storage medium 20 in FIG. 1. The storage medium 320 includes a data region 322 and a protected region 24. The data region 322 retains encrypted content 232 and copyright information conversion information 334, while the protected region 24 holds encrypted copyright information 36. For example, a CPU 12 stores the encrypted copyright information 36 in the protected region 24 and stores the encrypted content 232 and the copyright information conversion information 334 in the data region 322.

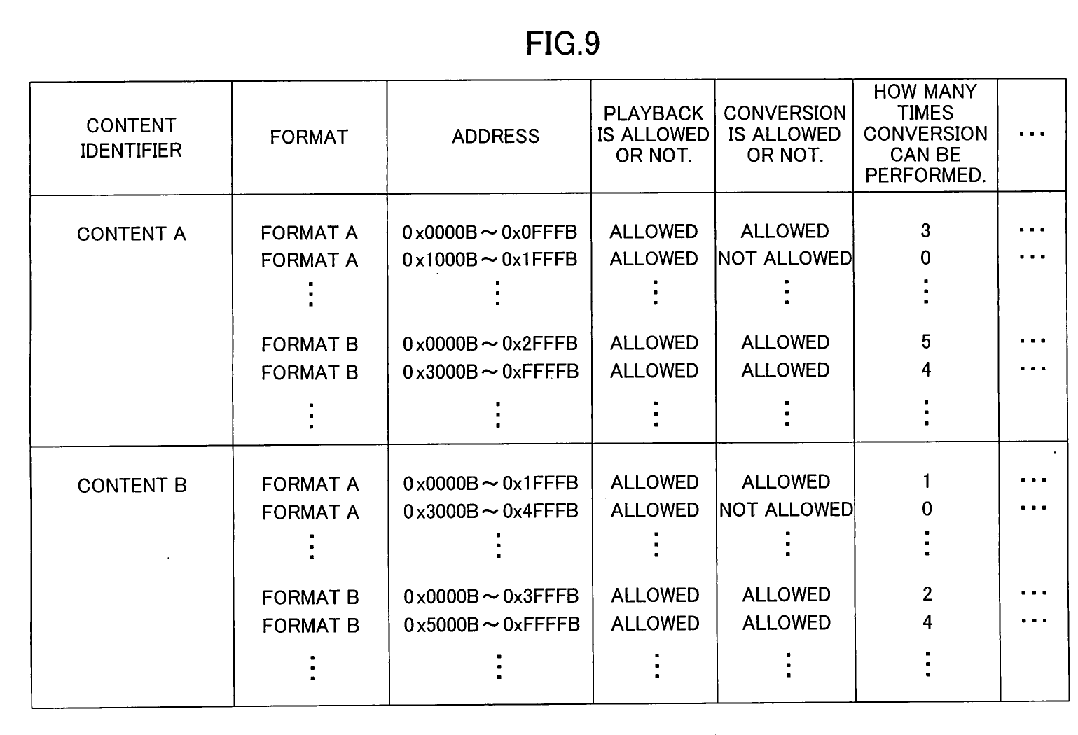

FIG. 9 is an explanatory view illustrating an example of the copyright information conversion information 334 shown in FIG. 8. As shown in FIG. 9, the copyright information conversion information 334 differs from the copyright information conversion information 234 shown in FIG. 6 primarily in that the copyright information conversion information 334 further contains address information for specifying parts of each content and thus contains information on the copyright of each content that corresponds not to the whole content but to the parts of the content. More specifically, where the format after conversion is format A, for example, the copyright information conversion information 334 contains, for the part of the content A located at addresses 0x0000B to 0x0FFFB, information indicating that playback is allowed, conversion is allowed, the allowable number of conversions is three, and the like, and contains, for the part of the content A located at addresses 0x1000B to 0x1FFFB, information indicating that playback is allowed, conversion is not allowed, the allowable number of conversions is zero, and the like.

For some formats, channel numbers, frame numbers or the like, instead of the addresses, may be used as the information for specifying parts of content.

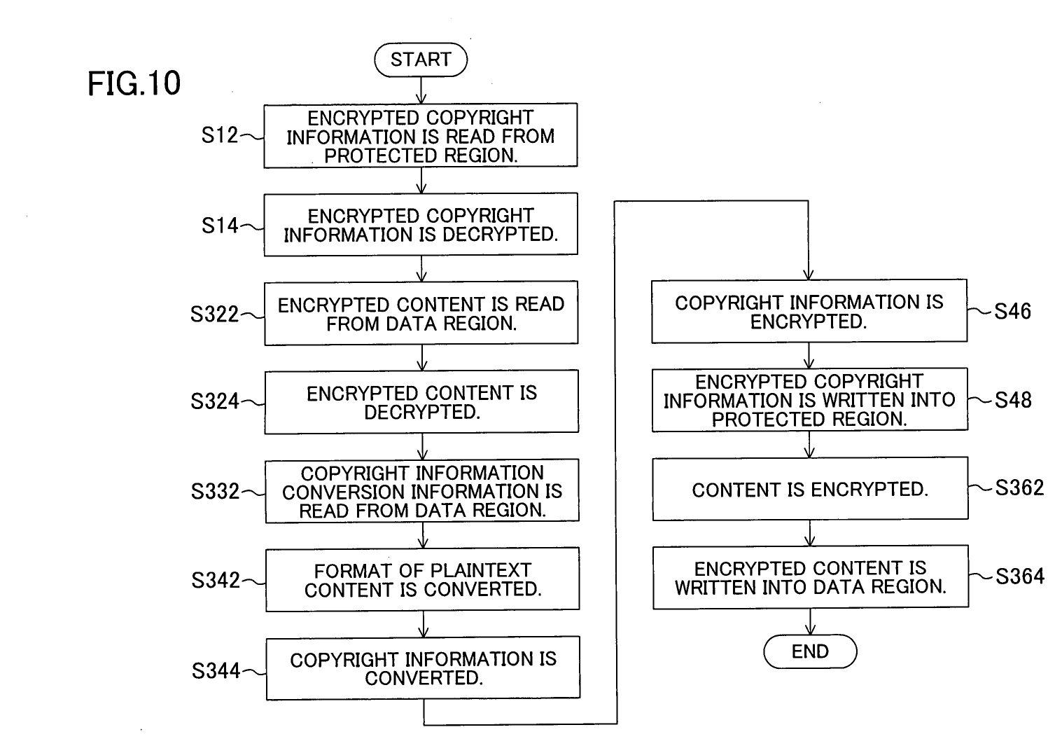

FIG. 10 is a flow chart indicating the sequence of processing steps in a copyright information management method according to the third embodiment of the present invention. With reference to FIG. 10, a case in which content A in format B is partially converted into content A in format A will be described as an example. Steps S12, S14, S46, and S48 are the same as those shown in FIG. 4, and steps S322 and S324 are the same as the steps S222 and S224, respectively, shown in FIG. 7, except in that the data region 322 instead of the data region 222 is accessed. The descriptions of these steps will be thus omitted herein.

In a step S332 shown in FIG. 10, the CPU 12 reads the copyright information conversion information 334 from the data region 322 in the storage medium 320. In a step S342, according to the copyright information conversion information 334, the CPU 12 performs the format conversion from the format B to the format A for part of plaintext content obtained in the step S324, which is located at the addresses 0x0000B to 0x0FFFB, for example.

In a step S344, according to the copyright information conversion information read in the step S332, the CPU 12 converts the copyright information into copyright information corresponding to the format A. In this step, the CPU 12 converts the copyright information in such a manner that the information on the format A for the part of the content A (at the addresses 0x0000B to 0x0FFFB) shown in FIG. 9 is contained. Since the conversion to the format A has been performed, the CPU 12 updates the information in the copyright information conversion information 334 on the format A for the part of the content A (at the addresses 0x0000B to 0x0FFFB). The CPU 12 stores the copyright information conversion information 334 after the update into the data region 322.

In a step S362, an encryption and decryption circuit 14 encrypts the part of the plaintext content A (at the addresses 0x0000B to 0x0FFFB) after the format conversion, thereby obtaining new encrypted content 232. In a step S364, the CPU 12 writes the encrypted content 232 obtained in the step S362 into the data region 322.

In this embodiment, since the copyright information conversion information 334 contains the information on the copyright on each content for the respective parts of the content, the copyright information can be set more flexibly for each part of the content.

### Fourth Embodiment

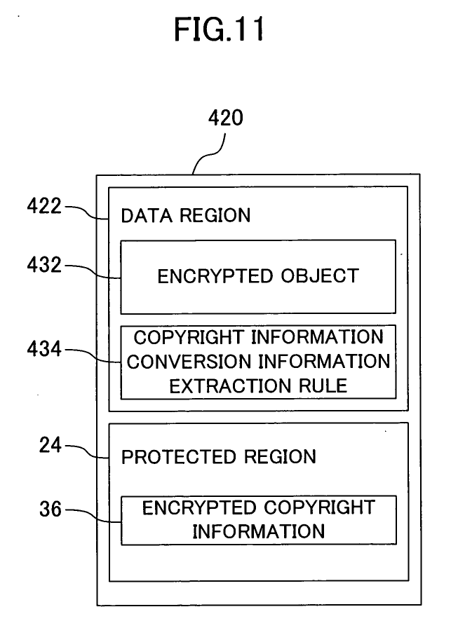

FIG. 11 is a block diagram illustrating the structure of a storage medium 420 according to a fourth embodiment and an example of information stored in the storage medium 420. In this embodiment, the storage medium 420 is used in place of the storage medium 20 in FIG. 1. The storage medium 420 includes a data region 422 and a protected region 24. The data region 422 retains an encrypted object 432 and a copyright information conversion information extraction rule 434, while the protected region 24 holds encrypted copyright information 36. For example, a CPU 12 stores the encrypted copyright information 36 in the protected region 24 and stores the encrypted object 432 and the copyright information conversion information extraction rule 434 in the data region 422.

The encrypted object 432 is information obtained by encrypting copyright-information-conversion-information-containing content. The copyright-information-conversion-information-containing content is information in which copyright information conversion information is embedded in the content according to a rule. The contents of the copyright information conversion information are the same as those shown in FIG. 6. However, the copyright information conversion information is not encrypted. The copyright information conversion information extraction rule 434 is data for extracting the copyright information conversion information from the copyright-information-conversion-information-containing content.

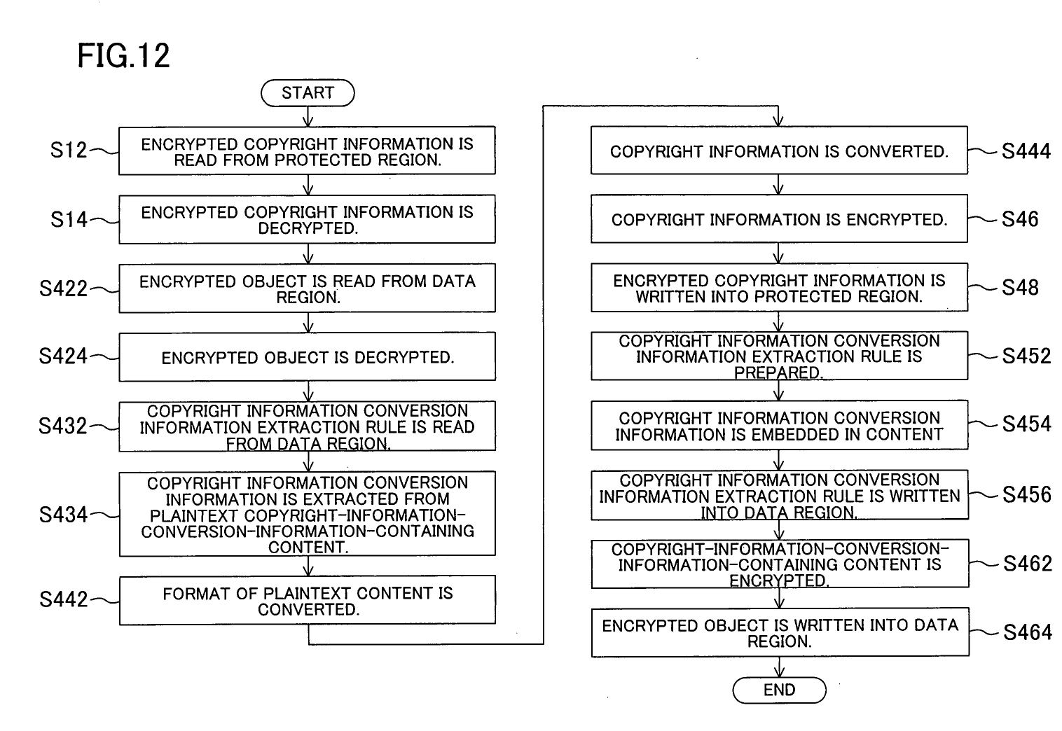

FIG. 12 is a flow chart indicating the sequence of processing steps in a copyright information management method according to the fourth embodiment of the present invention. With reference to FIG. 12, content format conversion will be described. Steps S12, S14, S46, and S48 are the same as those shown in FIG. 4, and the descriptions of these steps will be thus omitted herein.

In a step S422 shown in FIG. 12, the CPU 12 reads the encrypted object 432 from the data region 422 in the storage medium 420. In a step S424, an encryption and decryption circuit 14 decrypts the encrypted object 432 to obtain copyright-information-conversion-information-containing content in plain text.

In a step S432, the CPU 12 reads the copyright information conversion information extraction rule 434 from the data region 422. In a step S434, according to the copyright information conversion information extraction rule 434, the CPU 12 extracts the copyright information conversion information from the copyright-information-conversion-information-containing content to divide the copyright-information-conversion-information-containing content into the content in plain text and the copyright information conversion information.

In a step S442, the CPU 12 converts the format of the plaintext content obtained in the step S434 in accordance with the copyright information conversion information. In this embodiment, the format conversion from format B to format A is carried out as an example.

In the step S444, according to the extracted copyright information conversion information, the CPU 12 converts the copyright information into copyright information that corresponds to the format (the format A) of the content after the conversion. In this step, the CPU 12 converts the copyright information in such a manner that the information on the format A for the content A shown in FIG. 6 is contained. Since the conversion into the format A has been performed, the CPU 12 updates the information in the copyright information conversion information on the format A for the content A.

In a step S452, the CPU 12 prepares a new copyright information conversion information extraction rule 434 for embedding the copyright information conversion information in the content after the format conversion. In a step S454, according to the copyright information conversion information extraction rule 434 prepared in the step S452, the CPU 12 embeds the copyright information conversion information in the content after the format conversion, thereby obtaining copyright-information-conversion-information-containing content. In a step S456, the CPU 12 writes the copyright information conversion information extraction rule 434 prepared in the step S452 into the data region 422.

In a step S462, the encryption and decryption circuit 14 encrypts the copyright-information-conversion-information-containing content obtained in the step S454, thereby obtaining a new encrypted object 432. In a step S464, the CPU 12 writes the encrypted object 432 obtained in the step S462 into the data region 422.

In this embodiment, the copyright information conversion information is embedded in the content and is also encrypted. Therefore, unlike a case where copyright information conversion information is stored in a data region without being embedded and encrypted, it is possible to suppress unauthorized reading and alteration of the copyright information conversion information by the content user.

Also, since the copyright information conversion information is embedded in the content, it is possible to impose restrictions on processing of the content by conventional host devices and the like that do not process or refer to the copyright information conversion information.

In addition, the content producer and the host devices that conform to the copyright information conversion information extraction rule can set any extraction rule and thus can flexibly impose restrictions on processing of the content. For example, to share the content with the other host devices that conform to the copyright information conversion information extraction rule, the same extraction rule may be used, and to prevent processing of the content by the other host devices that conform to the copyright information conversion information extraction rule, a unique extraction rule may be used.

Furthermore, for the same content used by the same host device, it is possible to suppress unauthorized processing of the content by the content user, by changing the copyright information conversion information extraction rule each time the content is processed.

### Modified Example of the Fourth Embodiment

In this modified example, a copyright information conversion information extraction rule is encrypted and stored in a data region, the encrypted copyright information conversion information extraction rule is read and then decrypted, and the copyright information conversion information extraction rule is encrypted before the copyright information conversion information extraction rule is stored in the data region. In the other respects, the modified example is the same as the fourth embodiment.

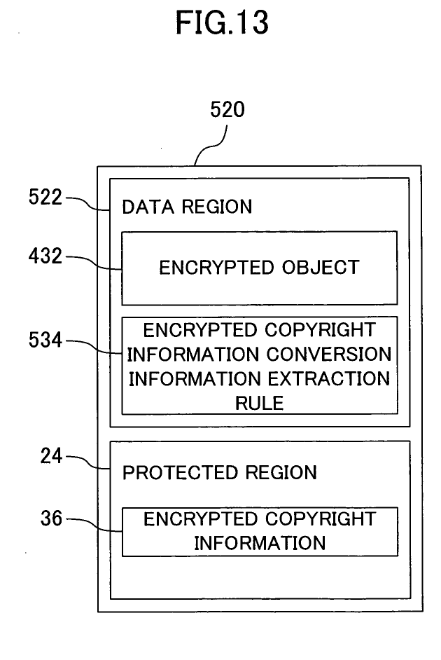

FIG. 13 is a block diagram illustrating the structure of a storage medium 520 according to the modified example of the fourth embodiment and an example of information stored in the storage medium 520. In this modified example, the storage medium 520 is used in place of the storage medium 20 in FIG. 1. The storage medium 520 includes a data region 522 and a protected region 24. The data region 522 retains an encrypted object 432 and an encrypted copyright information conversion information extraction rule 534, while the protected region 24 holds encrypted copyright information 36. For example, the CPU 12 stores the encrypted copyright information 36 in the protected region 24 and stores the encrypted object 432 and the encrypted copyright information conversion information extraction rule 534 in the data region 522. The encrypted copyright information conversion information extraction rule 534 is obtained by encrypting a copyright information conversion information extraction rule for extracting copyright information conversion information from copyright-information-conversion-information-containing content.

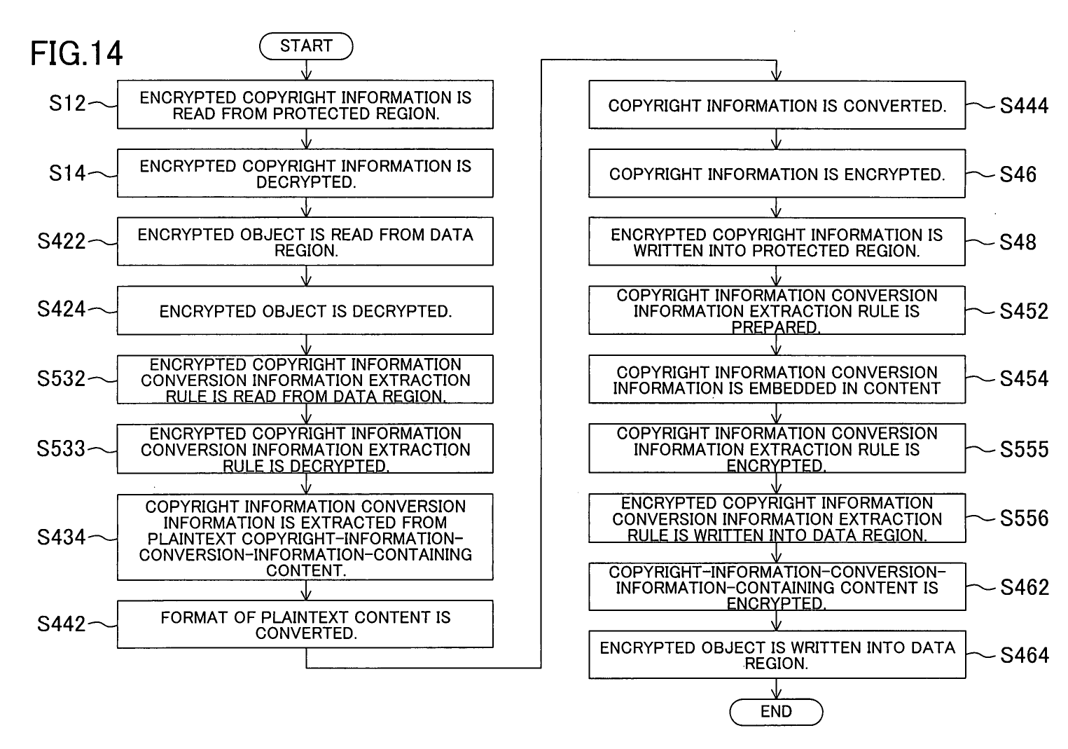

FIG. 14 is a flow chart indicating the sequence of processing steps in a copyright information management method according to the modified example of the fourth embodiment of the present invention. With reference to FIG. 14, content format conversion will be described. In FIG. 14, steps S532 and S533 are included in place of the step S432; steps S555 and S556 are included in place of the step S456; and the data region 522 instead of the data region 422 is accessed. In the other respects, the copyright information management method shown in FIG. 14 is the same as that shown in FIG. 12.

In the step S532, the CPU 12 reads the encrypted copyright information conversion information extraction rule 534 from the data region 522. In the step S533, the encryption and decryption circuit 14 decrypts the encrypted copyright information conversion information extraction rule 534 to obtain a copyright information conversion information extraction rule in plain text.

In the step S555, the encryption and decryption circuit 14 encrypts the new copyright information conversion information extraction rule prepared in the step S452. In the step S556, the CPU 12 writes the encrypted copyright information conversion information extraction rule 534 obtained in the step S555 into the data region 522.

In this modified example, since the copyright information conversion information extraction rule is encrypted, the copyright information conversion information is managed more securely.

### Fifth Embodiment

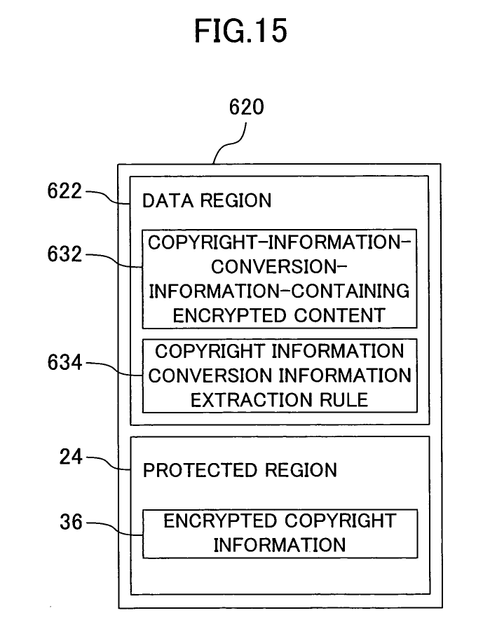

FIG. 15 is a block diagram illustrating the structure of a storage medium 620 according to a fifth embodiment and an example of information stored in the storage medium 620. In this embodiment, the storage medium 620 is used in place of the storage medium 20 in FIG. 1. The storage medium 620 includes a data region 622 and a protected region 24. The data region 622 retains copyright-information-conversion-information-containing encrypted content 632 and a copyright information conversion information extraction rule 634, while the protected region 24 holds encrypted copyright information 36. For example, a CPU 12 stores the encrypted copyright information 36 in the protected region 24 and stores the copyright-information-conversion-information-containing encrypted content 632 and the copyright information conversion information extraction rule 634 in the data region 622.

The copyright-information-conversion-information-containing encrypted content 632 is information in which copyright information conversion information has been embedded in the encrypted content in accordance with a rule. The contents of the copyright information conversion information are the same as those shown in FIG. 6. However, the copyright information conversion information is not encrypted. The copyright information conversion information extraction rule 634 is data for extracting the copyright information conversion information from the copyright-information-conversion-information-containing encrypted content 632.

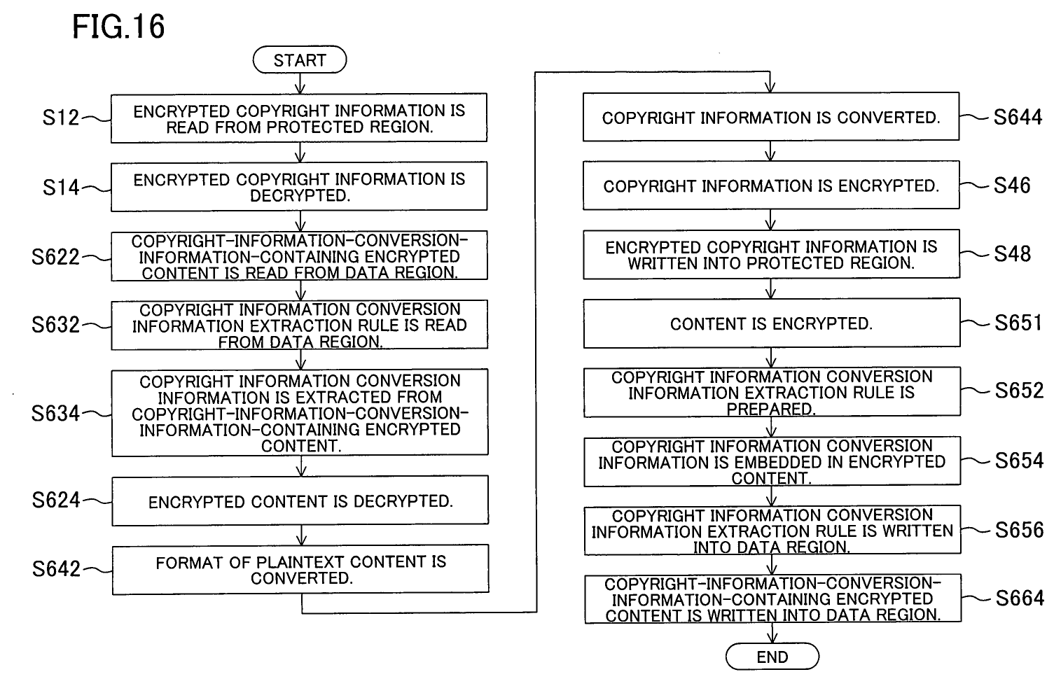

FIG. 16 is a flow chart indicating the sequence of processing steps in a copyright information management method according to the fifth embodiment of the present invention. With reference to FIG. 16, content format conversion will be described. Steps S12, S14, S46, and S48 are the same as those shown in FIG. 4, and the descriptions of these steps will be thus omitted herein.

In a step S622 shown in FIG. 16, the CPU 12 reads the copyright-information-conversion-information-containing encrypted content 632 from the data region 622 in the storage medium 620. In a step S632, the CPU 12 reads the copyright information conversion information extraction rule 634 from the data region 622.

In a step S634, according to the copyright information conversion information extraction rule 634, the CPU 12 extracts the copyright information conversion information from the copyright-information-conversion-information-containing encrypted content 632 to divide the copyright-information-conversion-information-containing encrypted content 632 into the encrypted content and the copyright information conversion information. In a step S624, an encryption and decryption circuit 14 decrypts the encrypted content to obtain content in plain text.

In a step S642, the CPU 12 converts the format of the plaintext content obtained in the step S624 in accordance with the copyright information conversion information. In this embodiment, the format conversion from format B to format A is carried out as an example. A step S644 is the same as the step S444 shown in FIG. 12.

In a step S651, the encryption and decryption circuit 14 encrypts the plaintext content after the format conversion, thereby obtaining new encrypted content. In a step S652, the CPU 12 prepares a new copyright information conversion information extraction rule 634 for embedding the copyright information conversion information in the encrypted content. In a step S654, according to the copyright information conversion information extraction rule 634 prepared in the step S652, the CPU 12 embeds the copyright information conversion information in the encrypted content obtained in the step S651, thereby obtaining new copyright-information-conversion-information-containing encrypted content 632.

In a step S656, the CPU 12 writes the copyright information conversion information extraction rule 634 prepared in the step S652 into the data region 622. In a step S664, the CPU 12 writes the copyright-information-conversion-information-containing encrypted content 632 obtained in the step S654 into the data region 622.

In this embodiment, the copyright information conversion information is embedded in the encrypted content. Therefore, unlike a case where copyright information conversion information is stored in a data region without being embedded, it is possible to suppress unauthorized reading and alteration of the copyright information conversion information by the content user.

### Modified Example of the Fifth Embodiment

In this modified example, a copyright information conversion information extraction rule is encrypted and stored in a data region, the encrypted copyright information conversion information extraction rule is read and then decrypted, and the copyright information conversion information extraction rule is encrypted before the copyright information conversion information extraction rule is stored in the data region. In the other respects, this modified example is the same as the fifth embodiment.

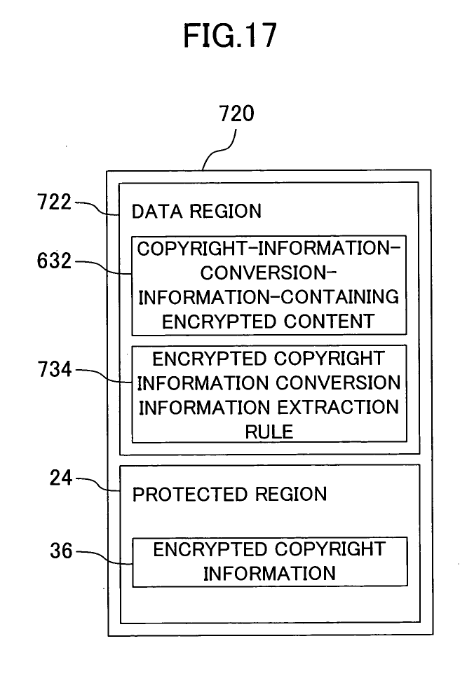

FIG. 17 is a block diagram illustrating the structure of a storage medium 720 according to the modified example of the fifth embodiment and an example of information stored in the storage medium 720. In this modified example, the storage medium 720 is used in place of the storage medium 20 in FIG. 1. The storage medium 720 includes a data region 722 and a protected region 24. The data region 722 retains copyright-information-conversion-information-containing encrypted content 632 and an encrypted copyright information conversion information extraction rule 734, while the protected region 24 holds encrypted copyright information 36. For example, the CPU 12 stores the encrypted copyright information 36 in the protected region 24 and stores the copyright-information-conversion-information-containing encrypted content 632 and the encrypted copyright information conversion information extraction rule 734 in the data region 722. The encrypted copyright information conversion information extraction rule 734 is obtained by encrypting a copyright information conversion information extraction rule for extracting copyright information conversion information from the copyright-information-conversion-information-containing encrypted content 632.

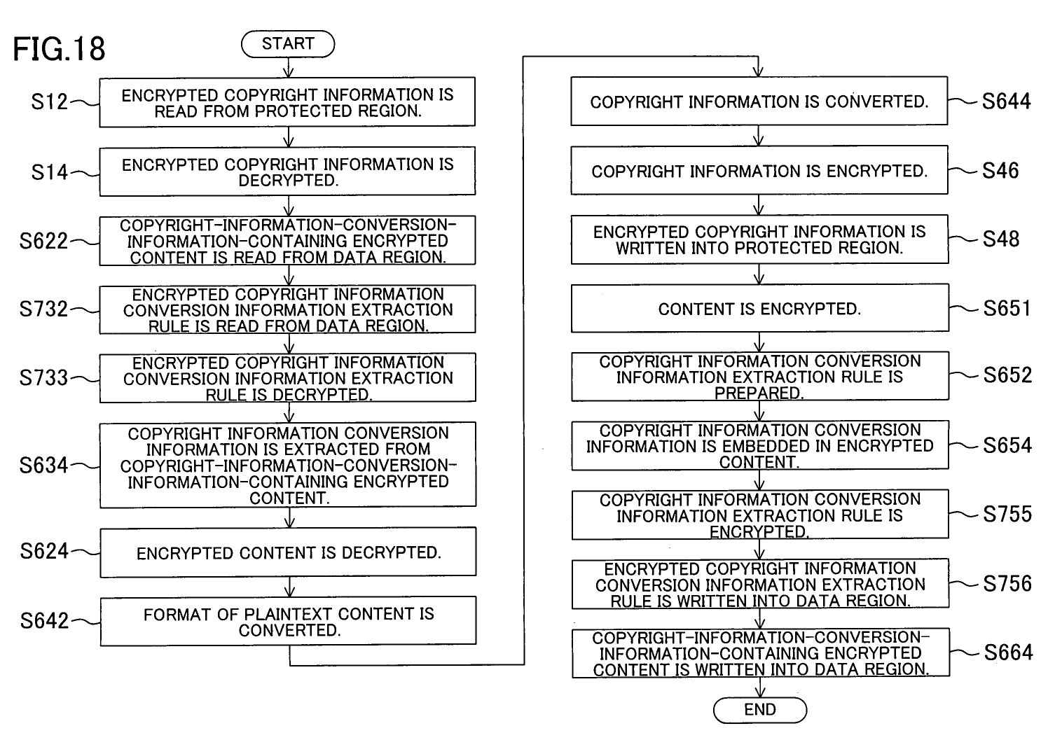

FIG. 18 is a flow chart indicating the sequence of processing steps in a copyright information management method according to the modified example of the fifth embodiment of the present invention. With reference to FIG. 18, content format conversion will be described. In FIG. 18, steps S732 and S733 are included in place of the step S632; steps S755 and S756 are included in place of the step S656; and the data region 722 instead of the data region 622 is accessed. In the other respects, the copyright information management method shown in FIG. 18 is the same as that shown in FIG. 16.

In the step S732, the CPU 12 reads the encrypted copyright information conversion information extraction rule 734 from the data region 722. In the step S733, the encryption and decryption circuit 14 decrypts the encrypted copyright information conversion information extraction rule 734 to obtain a copyright information conversion information extraction rule in plain text.

In the step S755, the encryption and decryption circuit 14 encrypts the new copyright information conversion information extraction rule prepared in the step S652. In the step S756, the CPU 12 writes the encrypted copyright information conversion information extraction rule 734 obtained in the step S755 into the data region 722.

In this modified example, since the copyright information conversion information extraction rule is encrypted, the copyright information conversion information is managed more securely.

### Sixth Embodiment

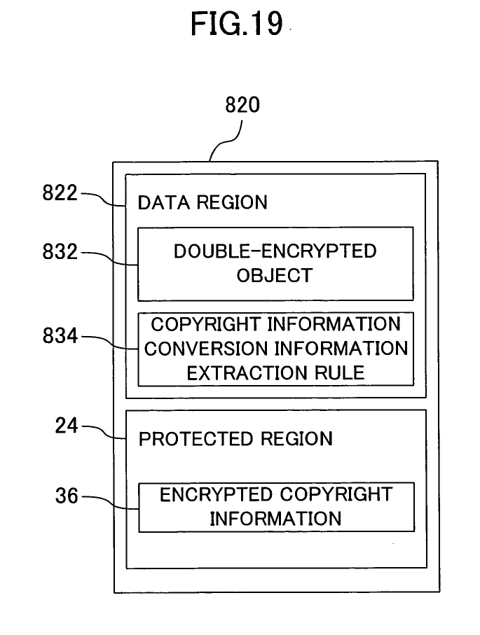

FIG. 19 is a block diagram illustrating the structure of a storage medium 820 according to a sixth embodiment and an example of information stored in the storage medium 820. In this embodiment, the storage medium 820 is used in place of the storage medium 20 in FIG. 1. The storage medium 820 includes a data region 822 and a protected region 24. The data region 822 retains a double-encrypted object 832 and a copyright information conversion information extraction rule 834, while the protected region 24 holds encrypted copyright information 36. For example, a CPU 12 stores the encrypted copyright information 36 in the protected region 24 and stores the double-encrypted object 832 and the copyright information conversion information extraction rule 834 in the data region 822.

The double-encrypted object 832 is information obtained by encrypting encrypted-copyright-information-conversion-information-containing content. The encrypted-copyright-information-conversion-information-containing content is information in which encrypted copyright information conversion information has been embedded in the content according to a rule. The contents of the encrypted copyright information conversion information are the same as those shown in FIG. 6. The copyright information conversion information extraction rule 834 is data for extracting the encrypted copyright information conversion information from the encrypted-copyright-information-conversion-information-containing content.

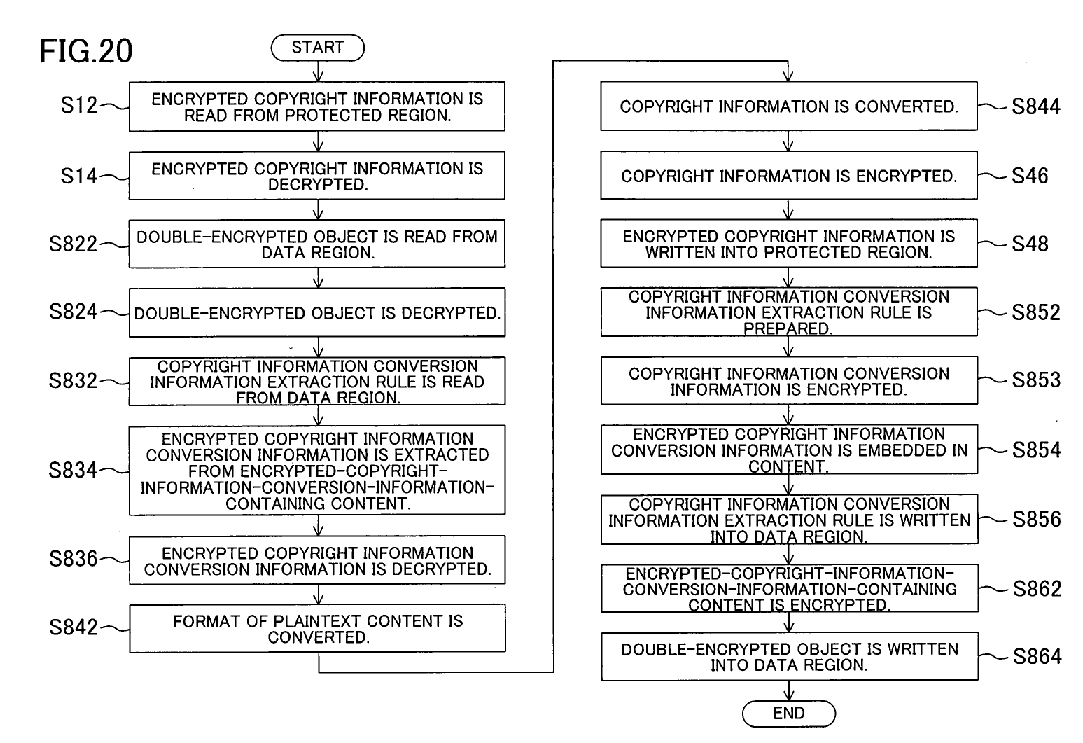

FIG. 20 is a flow chart indicating the sequence of processing steps in a copyright information management method according to the sixth embodiment of the present invention. With reference to FIG. 20, content format conversion will be described. Steps S12, S14, S46, and S48 are the same as those shown in FIG. 4, and the descriptions of these steps will be thus omitted herein.

In a step S822 shown in FIG. 20, the CPU 12 reads the double-encrypted object 832 from the data region 822 in the storage medium 820. In a step S824, an encryption and decryption circuit 14 decrypts the double-encrypted object 832 to obtain the encrypted-copyright-information-conversion-information-containing content.

In a step S832, the CPU 12 reads the copyright information conversion information extraction rule 834 from the data region 822. In a step S834, according to the copyright information conversion information extraction rule 834, the CPU 12 extracts the encrypted copyright information conversion information from the encrypted-copyright-information-conversion-information-containing content to divide the encrypted-copyright-information-conversion-information-containing content into the content in plain text and the encrypted copyright information conversion information. In a step S836, the encryption and decryption circuit 14 decrypts the encrypted copyright information conversion information to obtain copyright information conversion information in plain text.

In a step S842, the CPU 12 converts the format of the plaintext content obtained in the step S834 in accordance with the copyright information conversion information. In this embodiment, the format conversion from format B to format A is carried out as an example. A step S844 is the same as the step S444 in FIG. 12.

In a step S852, the CPU 12 prepares a new copyright information conversion information extraction rule 834 for embedding encrypted copyright information conversion information in the content after the format conversion. In a step S853, the encryption and decryption circuit 14 encrypts updated copyright information conversion information, thereby obtaining the encrypted copyright information conversion information.

In a step S854, according to the copyright information conversion information extraction rule 834 prepared in the step S852, the CPU 12 embeds the encrypted copyright information conversion information in the content after the format conversion, thereby obtaining new encrypted-copyright-information-conversion-information-containing content. In a step S856, the CPU 12 writes the copyright information conversion information extraction rule 834 prepared in the step S852 into the data region 822.

In a step S862, the encryption and decryption circuit 14 encrypts the encrypted-copyright-information-conversion-information-containing content obtained in the step S854 to obtain a new double-encrypted object 832. In a step S864, the CPU 12 writes the double-encrypted object 832 obtained in the step S862 into the data region 822.

In this embodiment, the encrypted copyright information conversion information is embedded in the content and the encrypted-copyright-information-conversion-information-containing content is also encrypted. Therefore, unauthorized reading and alteration of the copyright information conversion information by the content user are suppressed more effectively.

It should be noted that as described with reference to FIGS. 13 and 14, an encrypted copyright information conversion information extraction rule may be used. Specifically, an encrypted copyright information conversion information extraction rule may be stored in the data region 822 and may be decrypted after the encrypted copyright information conversion information extraction rule is read, and the copyright information conversion information extraction rule may be encrypted before the copyright information conversion information extraction rule is stored in the data region 822.

### Seventh Embodiment

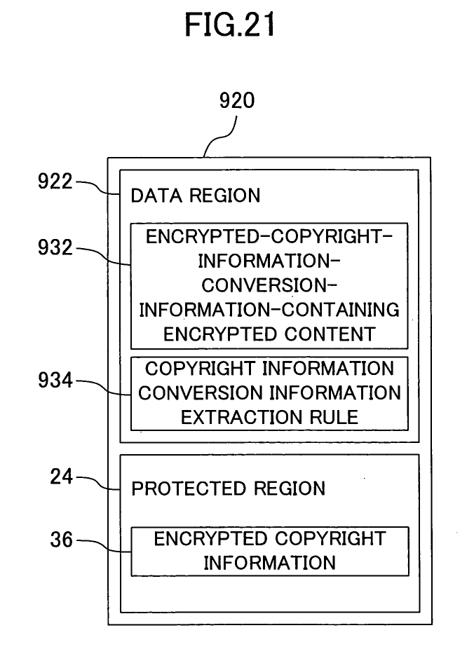

FIG. 21 is a block diagram illustrating the structure of a storage medium 920 according to a seventh embodiment and an example of information stored in the storage medium 920. In this embodiment, the storage medium 920 is used in place of the storage medium 20 in FIG. 1. The storage medium 920 includes a data region 922 and a protected region 24. The data region 922 retains encrypted-copyright-information-conversion-information-containing encrypted content 932 and a copyright information conversion information extraction rule 934, while the protected region 24 holds encrypted copyright information 36. For example, a CPU 12 stores the encrypted copyright information 36 in the protected region 24 and stores the encrypted-copyright-information-conversion-information-containing encrypted content 932 and the copyright information conversion information extraction rule 934 in the data region 922.

The encrypted-copyright-information-conversion-information-containing encrypted content 932 is information in which encrypted copyright information conversion information has been embedded in the encrypted content in accordance with a rule. The contents of the encrypted copyright information conversion information are the same as those shown in FIG. 6. The copyright information conversion information extraction rule 934 is data for extracting the encrypted copyright information conversion information from the encrypted-copyright-information-conversion-information-containing encrypted content 932.

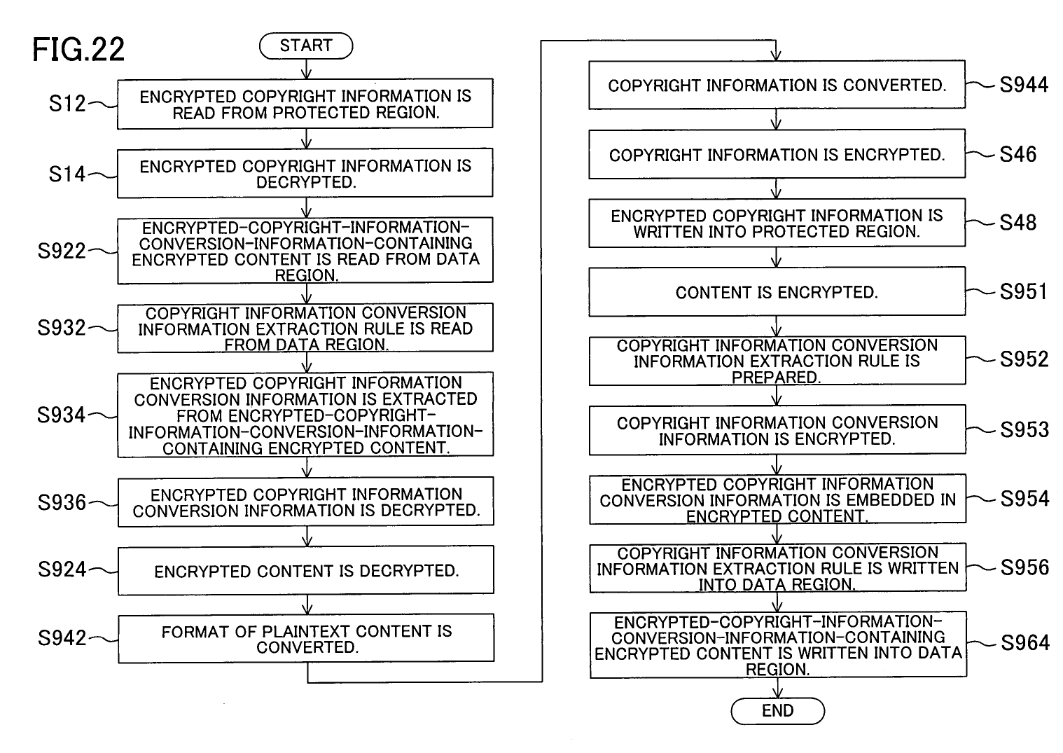

FIG. 22 is a flow chart indicating the sequence of processing steps in a copyright information management method according to the seventh embodiment of the present invention. With reference to FIG. 22, content format conversion will be described. Steps S12, S14, S46, and S48 are the same as those shown in FIG. 4, and the descriptions of these steps will be thus omitted herein.

In a step S922 shown in FIG. 22, the CPU 12 reads the encrypted-copyright-information-conversion-information-containing encrypted content 932 from the data region 922 in the storage medium 920. In a step S932, the CPU 12 reads the copyright information conversion information extraction rule 934 from the data region 922.

In a step S934, according to the copyright information conversion information extraction rule 934, the CPU 12 extracts the encrypted copyright information conversion information from the encrypted-copyright-information-conversion-information-containing encrypted content 932 to divide the encrypted-copyright-information-conversion-information-containing encrypted content 932 into the encrypted content and the encrypted copyright information conversion information. In a step S936, an encryption and decryption circuit 14 decrypts the encrypted copyright information conversion information to obtain copyright information conversion information in plain text. In a step S924, the encryption and decryption circuit 14 decrypts the encrypted content to obtain content in plain text.

In a step S942, the CPU 12 converts the format of the plaintext content obtained in the step S924 in accordance with the copyright information conversion information. In this embodiment, the format conversion from format B to format A is carried out as an example. A step S944 is the same as the step S444 in FIG. 12.

In a step S951, the encryption and decryption circuit 14 encrypts the plaintext content after the format conversion, thereby obtaining the encrypted content. In a step S952, the CPU 12 prepares a new copyright information conversion information extraction rule 934 for embedding encrypted copyright information conversion information in the encrypted content. In a step S953, the encryption and decryption circuit 14 encrypts updated copyright information conversion information, thereby obtaining the encrypted copyright information conversion information.

In a step S954, according to the copyright information conversion information extraction rule 934 prepared in the step S952, the CPU 12 embeds the encrypted copyright information conversion information obtained in the step S953 in the encrypted content obtained in the step S951, thereby obtaining new encrypted-copyright-information-conversion-information-containing encrypted content 932.

In a step S956, the CPU 12 writes the copyright information conversion information extraction rule 934 prepared in the step S952 in the data region 922. In a step S964, the CPU 12 writes the encrypted-copyright-information-conversion-information-containing encrypted content 932 obtained in the step S954 into the data region 922.

In this embodiment, the copyright information conversion information is encrypted and then embedded in the encrypted content. Therefore, unauthorized reading and alteration of the copyright information conversion information by the content user is suppressed more effectively.

It should be noted that as described with reference to FIGS. 13 and 14, an encrypted copyright information conversion information extraction rule may be used. Specifically, an encrypted copyright information conversion information extraction rule may be stored in the data region 922 and may be decrypted after the encrypted copyright information conversion information extraction rule is read, and the copyright information conversion information extraction rule may be encrypted before the copyright information conversion information extraction rule is stored in the data region 922.

### Eighth Embodiment

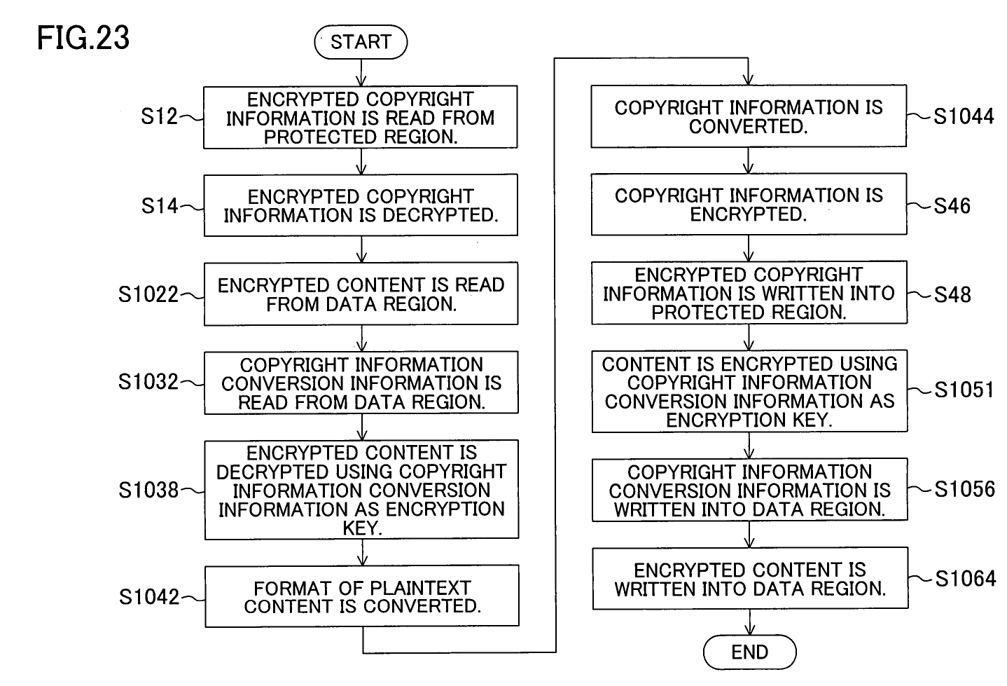

FIG. 23 is a flow chart indicating the sequence of processing steps in a copyright information management method according to an eighth embodiment of the present invention. With reference to FIG. 23, content format conversion will be described. Steps S12, S14, S46, and S48 are the same as those shown in FIG. 4, and the descriptions of these steps will be thus omitted herein. In this embodiment, the storage medium 320 shown in FIG. 8 is used in place of the storage medium 20 in FIG. 1. In this embodiment, it is assumed that encrypted content 232 has been encrypted using the whole or part of copyright information conversion information 334 as an encryption key.

In a step S1022 shown in FIG. 23, a CPU 12 reads the encrypted content 232 from the data region 322 in the storage medium 320. In a step S1032, the CPU 12 reads the copyright information conversion information 334 from the data region 322. In a step S1038, an encryption and decryption circuit 14 decrypts the encrypted content 232 by using the whole or part of the copyright information conversion information 334 as an encryption key, thereby obtaining content in plain text.

In a step S1042, the CPU 12 converts the format of the plaintext content obtained in the step S1038 in accordance with the copyright information conversion information 334. In this embodiment, the format conversion from format B to format A is carried out as an example. A step S1044 is the same as the step S344 in FIG. 10.

In a step S1051, the encryption and decryption circuit 14 encrypts the plaintext content after the format conversion by using, as an encryption key, the whole or part of the copyright information conversion information 334 updated in the step S1044, thereby obtaining new encrypted content 232. In a step S1056, the CPU 12 writes the updated copyright information conversion information 334 into the data region 322. In a step S1064, the CPU 12 writes the encrypted content 232 obtained in the step S1051 into the data region 322.

In this embodiment, the copyright information conversion information or part of the copyright information conversion information is used as the encryption key for the content. It is therefore possible to suppress unauthorized reading and alteration of the copyright information conversion information by the content user. It is also possible to impose restrictions on processing of the content, such as playback and alternation of the content, by host devices that do not use the copyright information conversion information as the encryption key for the content.

### Modified Example of the Eighth Embodiment

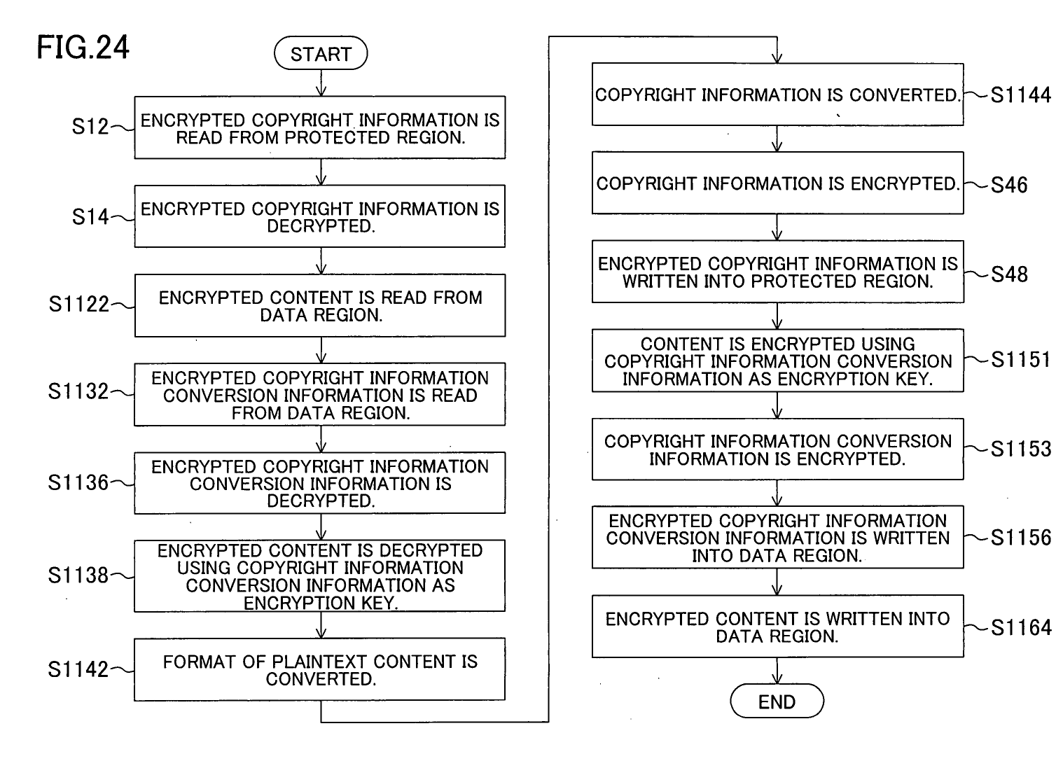

FIG. 24 is a flow chart indicating the sequence of processing steps in a copyright information management method according to a modified example of the eighth embodiment of the present invention. With reference to FIG. 24, content format conversion will be described. In this modified example, the storage medium 220 is used in place of the storage medium 20 in FIG. 1. In this modified example, it is assumed that encrypted content 232 has been encrypted using the whole or part of copyright information conversion information as an encryption key.

In a step S1122 shown in FIG. 24, the CPU 12 reads the encrypted content 232 from the data region 222 in the storage medium 220. In a step S1132, the CPU 12 reads encrypted copyright information conversion information 234 from the data region 222. In a step S1136, the encryption and decryption circuit 14 decrypts the encrypted copyright information conversion information 234 to obtain copyright information conversion information in plain text. In a step S1138, the encryption and decryption circuit 14 decrypts the encrypted content 232 by using the whole or part of the copyright information conversion information as an encryption key, thereby obtaining content in plain text.

In a step S1142, the CPU 12 converts the format of the plaintext content obtained in the step S1138 in accordance with the copyright information conversion information. In this modified example, the format conversion from format B to format A is carried out as an example. A step S1144 is the same as the step S244 in FIG.7.

In a step S1151, the encryption and decryption circuit 14 encrypts the plaintext content after the format conversion by using, as an encryption key, the whole or part of the copyright information conversion information updated in the step S1144, thereby obtaining new encrypted content 232. In a step S1153, the encryption and decryption circuit 14 encrypts the copyright information conversion information updated in the step S1144, thereby obtaining new encrypted copyright information conversion information 234.

In a step S1156, the CPU 12 writes the encrypted copyright information conversion information 234 obtained in the step S1153 into the data region 222. In a step S1164, the CPU 12 writes the encrypted content 232 obtained in the step S1151 into the data region 222.

In this modified example, since the copyright information conversion information that is the encryption key for the content is encrypted, it is possible to mange the copyright information conversion information and the content more securely.

In the foregoing embodiments, in the case where the copyright information conversion information or the encrypted copyright information conversion information is embedded in the unencrypted content, a rule for embedding digital watermarks may be used as the copyright information conversion information extraction rule. Specifically, it is possible to use a rule for embedding the copyright information conversion information in part of the content that satisfies specific requirements, in a specific frequency component in the content, or the like by utilizing the human audiovisual characteristics so that the copyright information conversion information is not perceived by human beings. More specifically, content in which copyright information conversion information has been embedded by using this rule may be stored in a storage medium, and when the copyright information conversion information or the encrypted copyright information conversion information is extracted and embedded, the extraction and the embedding may be performed in accordance with this rule.

Then, conventional host devices and the like that do not process or refer to the copyright information conversion information are allowed to process the content with fewer restrictions and thus can play back and alter the content.

Also, in the foregoing embodiments, in the case where the copyright information conversion information is embedded in the content or in the encrypted content, the copyright information conversion information may be divided into portions and the divided portions may be embedded.

Then, the processing of the content by conventional host devices and the like that do not process or refer to the copyright information conversion information is restricted significantly, whereby it becomes difficult for those devices to play back and alter the content.

Moreover, in the foregoing embodiments, a plurality of contents, a plurality of encrypted objects and the like may be stored in the storage medium.

Furthermore, the copyright information conversion information is not limited to the exemplary information shown in FIGS. 3, 6, and 9. Specifically, from the exemplary information, some of the items, such as whether or not copying is allowed, how many times copying can be performed, and the like, may be omitted, or other items may be added to the exemplary information. The content identifiers may be any information, so long as the information enables content identification, the format information may be any information, so long as the information enables format identification, and the attribute information may be any information on playback, recoding, copying, moving, and other processing of the content on which the copyright holder wants to put restrictions when the content is used.

Also, the storage medium is not limited to an SD memory card, but may be any medium, so long as the medium includes a data region, which is accessible without mutual authentication, and a protected region, which is accessible after mutual authentication.

Moreover, the mutual authentication and encryption/decryption method is not limited to CPRM, but may be any other method, so long as the method enables mutual authentication between a storage medium and digital devices and enables encryption and decryption of content itself and copyright information thereon.

As described above, according to the present invention, it is possible to protect content which is stored in a storage medium and whose copyright needs to be secured, in accordance with the format of the content, even after the format is converted. The present invention is therefore applicable to digital devices and the like that read and play back content from a storage medium.

What is claimed is:

1. A method for managing copyright information on content stored in a storage medium including a protected region, which is accessible after mutual authentication, and a data region, which is accessible without mutual authentication, the method comprising:
the step of storing, in the protected region, encrypted copyright information obtained by encrypting the copyright information, and
the content storing step of storing, in the data region, encrypted information that contains the content, and copyright information conversion information that contains copyright information, which is to be set for the content and corresponds to a format.

2. The method of claim 1, wherein the copyright information conversion information is encrypted, before the copyright information conversion information is stored.

3. The method of claim 1, wherein the copyright information conversion information contains the copyright information corresponding to part of the content.

4. The method of claim 1, wherein the content conforms to MPEG-2 (moving picture experts group-2) format, and
the copyright information conversion information contains copyright information that corresponds to MPEG-4 format.

5. The method of claim 1, further comprising an extraction rule storing step,
wherein the copyright information conversion information is embedded in the encrypted information that contains the content, and
in the extraction rule storing step, a copyright information conversion information extraction rule for extracting the copyright information conversion information is stored in the data region.

6. The method of claim 5, wherein, in the content storing step, an encrypted object is stored, the encrypted object being obtained by encrypting copyright-information-conversion-information-containing content obtained by embedding the copyright information conversion information in the content.

7. The method of claim 5, wherein, in the content storing step, copyright-information-conversion-information-containing encrypted content is stored, the copyright-information-conversion-information-containing encrypted content being obtained by embedding the copyright information conversion information in encrypted content obtained by encrypting the content.

8. The method of claim 5, wherein, in the content storing step, a double-encrypted object is stored, the double-encrypted object being obtained by further encrypting encrypted-copyright-information-conversion-information-containing content obtained by encrypting the copyright information conversion information and embedding the encrypted copyright information conversion information in the content.

9. The method of claim 5, wherein, in the content storing step, encrypted-copyright-information-conversion-information-containing encrypted content is stored, the encrypted-copyright-information-conversion-information-containing encrypted content being obtained by encrypting the copyright information conversion information and embedding the encrypted copyright information conversion information in encrypted content obtained by encrypting the content.

10. The method of claim 5, wherein the copyright information conversion information is embedded in the content in accordance with a rule for embedding digital watermarks.

11. The method of claim 5, wherein the copyright information conversion information is divided into portions in accordance with a given rule, and the divided portions are embedded.

12. The method of claim 5, wherein the copyright information conversion information extraction rule is encrypted.

13. The method of claim 1, wherein at least part of the copyright information conversion information is used as an encryption key for the encrypted information that contains the content.

14. The method of claim 13, wherein the copyright information conversion information is encrypted, before the copyright information conversion information is stored.

15. A method for managing copyright information on content stored in a storage medium including a protected region, which is accessible after mutual authentication, and a data region, which is accessible without mutual authentication, the method comprising:
the step of reading, from the protected region, encrypted copyright information obtained by encrypting the copyright information, and decrypting the encrypted copyright information, thereby obtaining the copyright information;
the content reading step of reading, from the data region, encrypted information that contains the content, and copyright information conversion information that contains copyright information, which is to be set for the content and corresponds to a format;
the decryption step of decrypting the encrypted information that contains the content;
the format conversion step of converting the format of the content; and
the copyright information conversion step of converting the copyright information into information that corresponds to a format in which the content after the format conversion is in, in accordance with the copyright information conversion information.

16. The method of claim 15, wherein the copyright information conversion information is encrypted, before the copyright information conversion information is stored, and
in the content reading step, the encrypted copyright information conversion information is read and decrypted.

17. The method of claim 15, wherein the copyright information conversion information contains the copyright information corresponding to part of the content, and
in the copyright information conversion step, the copyright information is converted so as to contain information corresponding to the part of the content after the format conversion, and the copyright information conversion information is updated.

18. The method of claim 15, wherein the content conforms to MPEG-2 format;
the copyright information conversion information contains copyright information that corresponds to MPEG-4 format;
in the format conversion step, the content is converted into the MPEG-4 format; and
in the copyright information conversion step, the copyright information is converted into information that corresponds to the MPEG-4 format.

19. The method of claim 15, further comprising:
an extraction rule reading step; and
a copyright information conversion information extraction step,
wherein the copyright information conversion information is embedded in the encrypted information that contains the content;
in the extraction rule reading step, a copyright information conversion information extraction rule for extracting the copyright information conversion information is read from the data region; and
in the copyright information conversion information extraction step, the copyright information conversion information is extracted from the encrypted information that contains the content, in accordance with the copyright information conversion information extraction rule.

20. The method of claim 19, wherein in the content reading step, an encrypted object is read, the encrypted object being obtained by further encrypting copyright-information-conversion-information-containing content obtained by embedding the copyright information conversion information in the content;
in the decryption step, the encrypted object is decrypted to obtain the copyright-information-conversion-information-containing content; and
in the copyright information conversion information extraction step, the copyright information conversion information is extracted from the copyright-information-conversion-information-containing content to obtain the content.

21. The method of claim 19, wherein, in the content reading step, copyright-information-conversion-information-containing encrypted content is read, the copyright-information-conversion-information-containing encrypted content being obtained by embedding the copyright information conversion information in encrypted content obtained by encrypting the content;
in the copyright information conversion information extraction step, the copyright information conversion information is extracted from the copyright-information-conversion-information-containing encrypted content to obtain the encrypted content; and
in the decryption step, the encrypted content is decrypted to obtain the content.

22. The method of claim 19, wherein in the content reading step, a double-encrypted object is read, the double-encrypted object being obtained by further encrypting encrypted-copyright-information-conversion-information-containing content obtained by encrypting the copyright information conversion information and embedding the encrypted copyright information conversion information in the content;
in the decryption step, the double-encrypted object is decrypted to obtain the encrypted-copyright-information-conversion-information-containing content; and
in the copyright information conversion information extraction step, the encrypted copyright information conversion information is extracted from the encrypted-copyright-information-conversion-information-containing content to obtain the content, and the encrypted copyright information conversion information is decrypted.

23. The method of claim 19, wherein in the content reading step, encrypted-copyright-information-conversion-information-containing encrypted content is read, the encrypted-copyright-information-conversion-information-containing encrypted content being obtained by encrypting the copyright information conversion information and embedding the encrypted copyright information conversion information in encrypted content obtained by encrypting the content;
in the copyright information conversion information extraction step, the encrypted copyright information conversion information is extracted from the encrypted-copyright-information-conversion-information-containing encrypted content to obtain the encrypted content, and the encrypted copyright information conversion information is decrypted; and
in the decryption step, the encrypted content is decrypted to obtain the content.

24. The method of claim 19, further comprising an extraction rule decryption step,
wherein the copyright information conversion information extraction rule is encrypted;
in the extraction rule reading step, the encrypted copyright information conversion information extraction rule is read; and
in the extraction rule decryption step, the encrypted copyright information conversion information extraction rule is decrypted.

25. The method of claim 19, further comprising a copyright information conversion information embedding step,
wherein, in the copyright information conversion step, the copyright information conversion information is updated; and
in the copyright information conversion information embedding step, the updated copyright information conversion information is embedded in the content or in encrypted content obtained by encrypting the content, in accordance with the copyright information conversion information extraction rule.

26. The method of claim 25, further comprising the step of preparing a new copyright information conversion information extraction rule,
wherein, in the copyright information conversion information embedding step, embedding is performed in accordance with the new copyright information conversion information extraction rule.

27. The method of claim 15, wherein at least part of the copyright information conversion information is used as an encryption key for the encrypted information that contains the content; and
in the decryption step, the decryption is performed using the copyright information conversion information.

28. The method of claim 27, wherein the copyright information conversion information is encrypted, before the copyright information conversion information is stored; and
in the content reading step, the encrypted copyright information conversion information is read and decrypted.

29. The method of claim 27, further comprising an encryption step,
wherein, in the copyright information conversion step, the copyright information conversion information is updated; and
in the encryption step, at least part of the updated copyright information conversion information is used as an encryption key to encrypt the content after the format conversion.
